(19) United States
(12) Patent Application Publication
(10) Pub. No.: US 2005/0241453 A1
(43) Pub. Date: Nov. 3, 2005

(54) Veneer slicing blade

(76) Inventors: Armin Heiner, Hohenroda (DE); Jean Meyer, Friedewald (DE); Heinrich Weppler, Ludwigsau (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/522,930

(22) PCT Filed: Jul. 1, 2003
(86) PCT No.: PCT/EP03/06968

§ 371 Date: Jan. 24, 2005

(30) Foreign Application Priority Data
Jul. 26, 2002 (DE) 102 34 279.2

(51) Int. Cl. B26D 5/08

(52) U.S. Cl. 83/613

(57) ABSTRACT

In known veneer slicing blades, wherein a block of wood is guided in front of a blade in an eccentrically rotational manner, the relatively large remnants of large wooden blocks cannot be measured. If the residual thickness of the wooden block is small, the edges move away in an elastic manner from the blade, leading to tom edges and correspondingly bad veneer quality. The aim of the invention is to improve a staylog machine in such a way that an evenly high veneer quality can be obtained even in the event of extensive use of said block of wood. This is achieved by providing displaceable means for supporting the longitudinal ends of the block of wood (16) protruding from the bearing surface (15) on the timber-frame (12).

The invention relates to an apparatus for eccentrically cutting veneer from a flitch according to the introductory clause of claim 1.

Such an apparatus is used to cut thin sheets, also called veneers, from a wood flitch. The process is also called slicing. In it the flitch is secured to a planar support surface of a beam. It is rotatable about a horizontal axis so that with each revolution a veneer is cut off by a blade extending parallel to the rotation axis and movable toward the beam. Such an apparatuses is also known as a stay-log veneer machine.

A tangential veneer-slicing machine is known from EP 0,584,268 that holds four flitches on a beam (flitch table). Clamp dogs with oval heads are used that are rotatable on the flitch table and that fit releasably in grooves cut in the flitch.

German 30 26 162 describes a similar stay-log veneer-slicing machine where dogs engage in grooves in the back face of the flitch to hold the flitch. In addition to these dogs, separate retaining claws engage laterally into the flitch. These claws can be swung out of the way when the flitch has been cut down to a predetermined size.

The known stay-log veneer-slicing machine either has a beam with relatively wide support faces and thus considerable thickness. This has the disadvantage that the last scrap part of the flitch, which cannot be cut into veneer because the blade would touch the beam, is still fairly large and as a result the wood is not all used for making veneer and must be treated as scrap.

A relatively narrow beam is known, but it has the dangerous disadvantage that when the flitch has been cut well down its edge regions bend when engaged by the blade. This leads to tearing of the edge regions of the flitch and/or to sloppy cuts so that the thickness of the edge regions of the veneer sheets is not uniform.

It is an object of the invention so to improve on a stay-log veneer-slicing machine that without reducing productivity it is possible to produce high-quality veneers while using the maximum possible amount of the flitch.

This object is achieved by the characterizing clause of claim 1. The provision on the beam of means for moving into position and supporting longitudinal edge regions of the flitch projecting past the support face makes it possible to make the beam relatively slim with a relatively narrow support face for the flitch. As a result it can be almost completely reduced to veneer before there is any danger of the blade hitting the beam. On the other hand the flitch edge regions projecting laterally past the support face are supported. This is particularly important for wide flitches that, as the cutting operation increases, become ever thinner. The support means reduces the danger of vibration and deflection of the longitudinal edge regions of the flitch. As a result veneer slices of uniform high quality are produced right up to the end of the cutting operation.

Since the support means is movable, it can be moved out of the path of the blade shortly before the end of the cutting operation. Thus all but a small scrap of the flitch can be reduced to a veneer.

The invention is further described with reference to a schematically illustrated embodiment shown in the drawing. Therein:

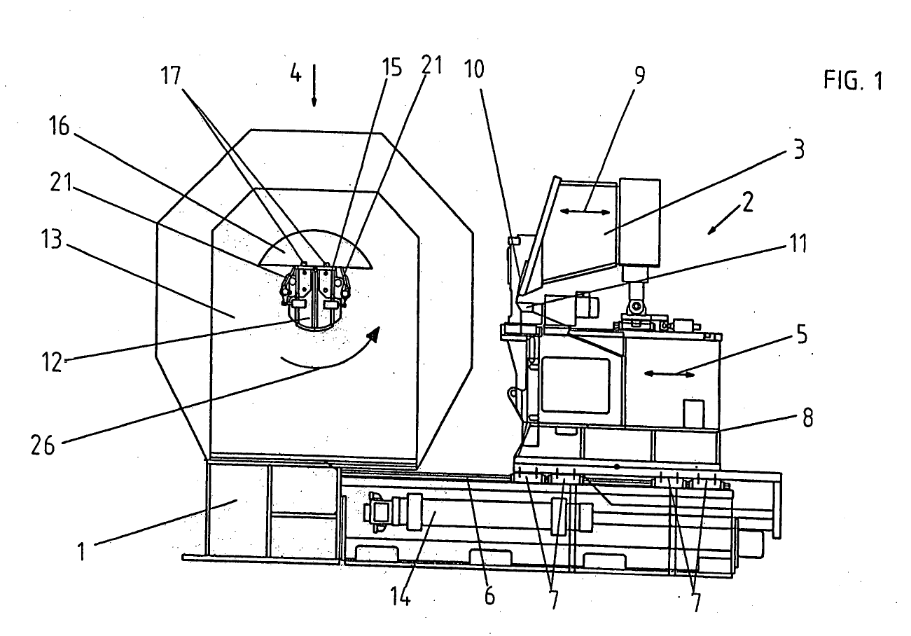

FIG. 1 is an end view of a stay-log veneer-slicing machine according to the invention;

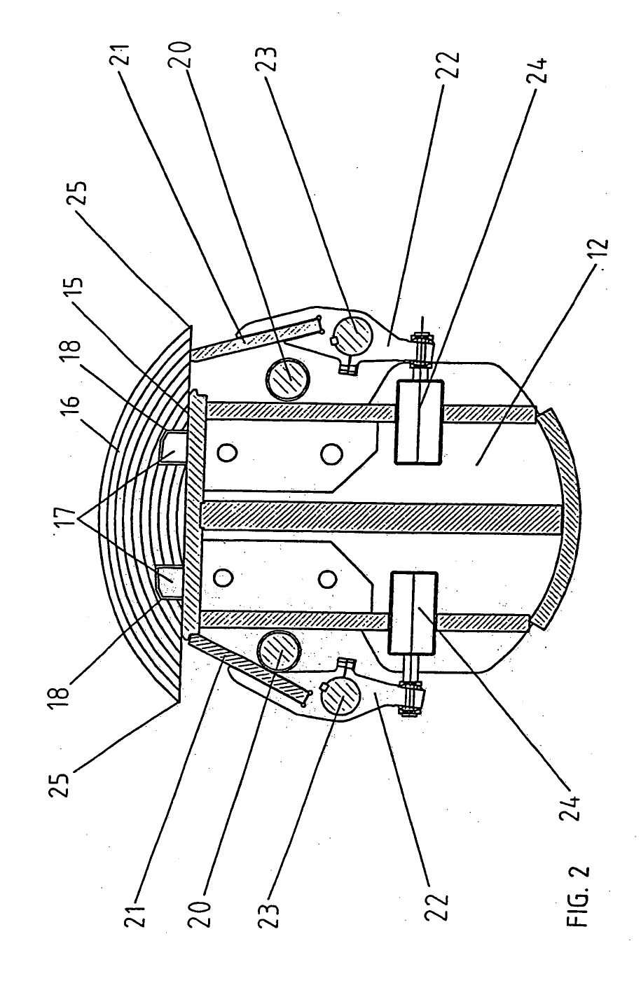

FIG. 2 is a detailed section through a log bar; and

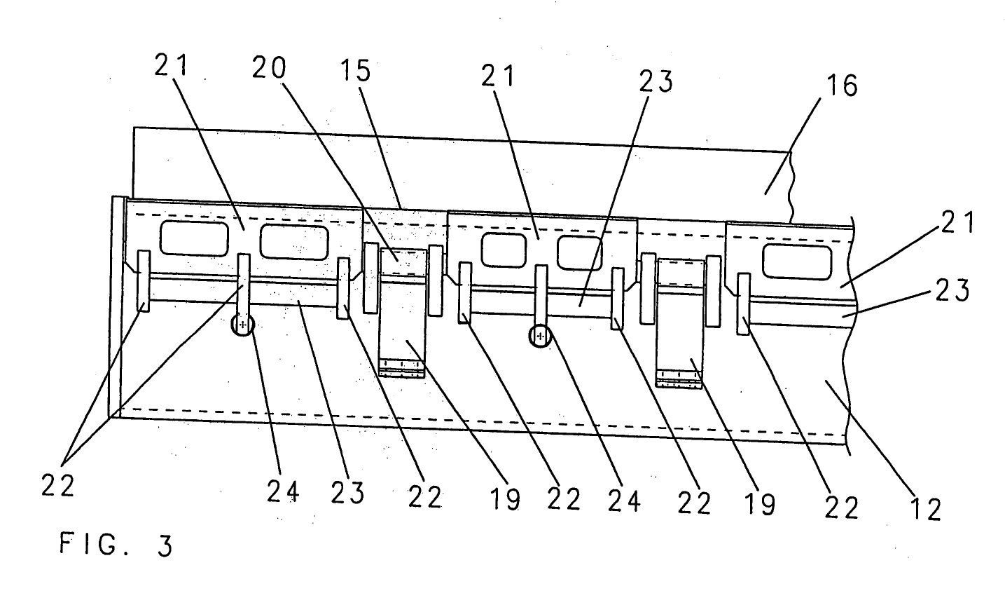

FIG. 3 is a side view of a part of the log bar.

As shown in FIG. 1 a veneer-slicing machine has a stationary frame 1 carrying along one side a tool slide 2 with a blade holder 3 and on the other side a stay-log beam 4.

The tool slide 2 is reciprocal in a horizontal plane on two parallel rails 6 as shown by arrow 5. To this end the tool slide 2 is shiftable by hydraulic cylinders 14 and mounted on guides 7 that are fixed to a machine frame 8 so they have minimal play and cannot twist on the rails 6.

An upper region of the machine frame 8 carries the blade holder 3 for a blade 10 that is shiftable in the direction of arrow 9 and that is pivotal about an axis at a lower cutting edge of the blade 10. The blade 10 and its cutting edge extend at a right angle to the movement direction of the tool slide 2. To this end the blade 10 is mounted on the side of the blade holder 3 that is closer to the stay-log beam 4. The pivotal and sliding movements of the blade holder 3 relative to the machine frame 8 are necessary to adjust its position relative to a below-described pusher bar 11 and are effected by various hydraulic cylinders.

Below and parallel to the blade 10, the machine frame 8 carries the pusher bar 11. The pusher bar 11 and the blade 10 are set such that in use they are slightly spaced from one another.

The machine frame 8 carries further unillustrated devices for carrying off the sliced veneer sheets.

The stay-log beam 4 is mounted on the frame 1 such that the horizontal longitudinal axis of its log bar 12 extends parallel to the cutting edge of the blade 10. The log bar 12 shown clearly in FIGS. 2 and 3 is rotatable between two housing walls 13 and connected to an unillustrated drive. A flitch 16 is clamped to a planar support face 15 of the log bar 12 by retaining dogs 17 that project in two rows parallel to the longitudinal axis of the log bar 12 from the support face 15, the rows of retaining dogs 17 being movable toward and away from one another by unillustrated actuators. The retaining dogs 17 engage in grooves 18 that are cut in a back face of the flitch 16. The spacing of the dogs 17 and of the grooves 18 is the same.

In addition to the retaining dogs 17, both longitudinal edge regions of the log bar 12 that flank the support face 19 have holding claws 19 that are mounted on first shafts 20 pivotal at each side so that can be pressed by rotation about an axis parallel to the longitudinal axis of the log bar 12 into a work position next to the flitch 16 or into a rest position against the sides of the log bar 12. Each first shaft 20 is connected to an unillustrated rotary drive.

This far the veneer-slicing machine corresponds to the prior art.

The improvement according to the invention comprises extensible and retractile means for supporting longitudinal edge regions 25 of the flitch 16 projecting past the edges of the log bar 12. When extended, this support means engages from below against the bottom face of the flitch 16 in the plane of the support face 15 against the longitudinal edges 25 near the support face 15.

The means for supporting includes support plates 21 that are at the sides of the log bar 12 on which the retaining claws 19 are mounted. The support plates 21 are located such that the support claws 19 and plates 21 alternate along the length of the log bar 12. Each support plate 21 is comprised of a metal plate about 10 to 15 mm thick that has an outer longitudinal edge secured by three uniformly spaced arms 22 on a second shaft 23. The opposite inner longitudinal edge is positioned in the extended position (work position) in the plane of the support face 15 and bears in line contact on one of the edge regions 25 of the clamped flitch 16. In the rest position the inner longitudinal edge of the support plate 21 bears against the log bar 12. To reduce weight, each support plate 21 is cut out.

The second shaft 23 is pivotally mounted in unillustrated supports that are fixed on the log bar 12.

Each arm 22 has as seen endwise of the second shaft 23 the shape of a hand that engages around the respective support plate 21 at its outer longitudinal edge. Each arm 22 is rotationally fixed on the respective shaft 23 by, for example, a screw clamp. The means for supporting have hydraulic cylinders 24 acting as actuators. To this end the middle one of the three arms 22 of each plate 21 is connected on its opposite arm that is extended with a pivot of a respective one of the hydraulic cylinders 24 that are fixed on the log bar 12. The thickness of each arm 22 is about 25 mm.

The means for supporting is connected with a control system for controlling the cutting operation. The control system is connected to the hydraulic cylinder 24.

In operation of the machine, which with the exception of the use of the support plates 21 is the same as in the prior art, the tool slide 2 is retracted to the maximum spacing from the stay-log beam 4, into the so-called rest position. A flitch 16 is secured by means of the dogs 17 and claws 19 to the log bar 12 and the support plates 21 are moved into the work position. The tool slide 2 is advanced into a work position so that there is a tiny horizontal gap between the orbit of the outermost portion of the flitch 16 and the cutting edge of the blade 10. The drive for the log bar 12 is then turned on so that it rotates together with the clamped flitch about its longitudinal axis counterclockwise as shown by arrow 26 in FIG. 1. This way the portion of the flitch 16 closer to the tool slide 2 is moving upward. Once the nominal rotation speed is reached, the tool slide 2 is shifted inward toward the flitch 16 so that a veneer of the desired thickness is sliced off during the upward movement.

Once the log bar 12 has reached a position in which the support face 15 is directed upward, the tool slide 2 is indexed inward toward the stay-long beam 4, the displacement being equal to the desired thickness of the veneer. This step is repeated until so many veneer slices have ben cut off the flitch 16 that only a minimal scrap part of the flitch 16 is left, one that cannot be cut because the blade 10 would engage the log bar. The veneer slicing machine is stopped automatically.

The cut-off veneer slices are carried off automatically.

During the slicing, that is without interrupting the process, first the holding claws 19 are displaced back into their rest positions before the cutting edge of the blade 10 gets near them so that it cannot contact the retaining claws 19. FIG. 3 shows the retaining claws 19 in the rest position. Later the support plates 21 are moved during the slicing operation into their rest positions, shortly before they could come into contact with the cutting edge of the blade 10. To this end the pistons of the hydraulic cylinders 24 are extended.

In order to remove the scrap part of the flitch 16 the tool slide 2 is moved back into its rest position. Then a new flitch 16 is clamped in place, and the process starts over again.

1-6. (canceled)

7. A veneer-slicing machine comprising:
a frame;
a log beam extending along and rotatable on the frame about an axis and having a generally planar and longitudinally extending support face having a pair of longitudinal edges;
means for securing an elongated flitch to the support face with longitudinal edge portions of the flitch projecting transversely past the longitudinal edges of the support face;
a blade on the frame having a cutting edge extending substantially parallel to the axis and displaceable on the frame transversely of the axis, whereby, when the log beam is rotated to orbit the flitch about the axis and the blade is displaced into the orbit of the flitch, the blade slices veneer from the flitch; and
respective support members each displaceable on the log bar between a work position bearing generally at the plane on a respective one of the edge regions of the flitch and a rest position retracted back from the plane;
means for displacing the support members into the work positions during rotation of the log beam and slicing of veneer from the flitch for supporting the edge regions of the flitch and preventing deformation of the flitch.

8. The veneer-slicing machine defined in claim 7 wherein the members are plates having straight longitudinal edges engageable with the flitch at the plane.

9. The veneer-slicing machine defined in claim 8 wherein the plates are pivotal between the work and rest positions.

10. The veneer-slicing machine defined in claim 9 wherein the means for displacing include actuators braced against the frame.

11. The veneer-slicing machine defined in claim 10 wherein the actuators are hydraulic cylinders.

12. The veneer-slicing machine defined in claim 9 wherein the plates are pivotal about axes parallel to the log-bar axis.
